(19) United States
(12) Patent Application Publication
(10) Pub. No.: US 2024/0400275 A1
(43) Pub. Date: Dec. 5, 2024

(54) SYSTEMS AND METHODS FOR INDICATING TAMPERING OF A CONTAINER

(71) Applicant: THE BOEING COMPANY, Arlington, VA (US)

(72) Inventors: Sean Michael Flinn, Lake Stevens, WA (US); Derrick Brian Pruitt, Bothell, WA (US); Gregory Thomas Eisele, Seattle, WA (US)

(73) Assignee: THE BOEING COMPANY, Arlington, VA (US)

(21) Appl. No.: 18/327,966

(22) Filed: Jun. 2, 2023

(51) Int. Cl. B65D 55/02; B64D 11/06; B65D 43/16; B65D 51/24

(52) U.S. Cl. CPC B65D 55/026; B64D 11/0631; B65D 43/16; B65D 51/243; B65D 2251/1066; B65D 2401/00; B65D 2543/00194; B65D 2543/00537

(57) ABSTRACT

A container, such as a life vest box secured to a seat within an internal cabin of an aircraft, includes a housing defining an internal compartment for storing one or more items, such as a life vest. A door is moveably coupled to the housing. The door is moveable between a closed position in which the internal compartment is closed, and an open position in which the internal compartment is accessible. A system for indicating tampering includes a tamper indicator coupled to one or both of the housing or the door. The tamper indicator is moveable between a stowed position and a tamper-indicating position.

### FIELD OF THE DISCLOSURE

Examples of the present disclosure generally relate to systems and methods for indicating tampering of a container, such as a life vest box secured to a seat within an internal cabin of an aircraft.

### BACKGROUND OF THE DISCLOSURE

Commercial aircraft are used to transport passengers between various locations. Typically, each passenger seat within a passenger cabin is equipped with a life preserver (“life vest”) stored in a box, pouch, or other such container mounted underneath a seat pan, cushion, or the like. Certain regulations, such as promulgated by the United States Federal Aviation Administration (FAA), require that life preservers or storage locations for life vests must be designed so that tampering is evident.

In general, any indication of tampering of life vest boxes is required to be easily visible to an inspector moving about the cabin. Further, manipulation of an indication of tampering to make it appear as it has not been tampered must be prevented.

Known security devices for life vest boxes include plastic padlocks, and plastic stickers. Both types provide security. However, the padlocks typically require a piece of plastic to be broken (for example, sheared), which increases the difficulty of opening a door of the life vest box. In contrast, the stickers offer little resistance to opening the door of the life vest box, but may not provide clear visibility of tampering.

### SUMMARY OF THE DISCLOSURE

A need exists for an efficient and effective system and method for indicating tampering of a container, such as a life vest box within an internal cabin of a vehicle.

With that need in mind, certain examples of the present disclosure provide a container including a housing defining an internal compartment for storing one or more items. A door is moveably coupled to the housing. The door is moveable between a closed position in which the internal compartment is closed, and an open position in which the internal compartment is accessible. A system for indicating tampering includes a tamper indicator coupled to one or both of the housing or the door. The tamper indicator is moveable between a stowed position and a tamper-indicating position.

In at least one example, the tamper indicator is moved from the stowed position to the tamper-indicating position as the door is moved from the closed position toward the open position.

In at least one example, the tamper indicator is spring-biased.

The door can be transparent. In at least one example, the tamper indicator in the tamper-indicating position is visible through the door.

In at least one example, the container is a life vest box configured to be secured to a seat within an internal cabin of a vehicle.

In at least one example, the tamper indicator includes a proximal end moveably secured to a bracket. The bracket is secured to an interior surface of the door. A main body extends between the proximal end and a distal end. In at least one example, a torsion spring couples the proximal end to the bracket.

In at least one example, the tamper indicator in the tamper-indicating position is biased against an interior surface of the door.

In at least one example, the housing includes a protuberance extending from one or more interior surfaces. The protuberance holds the tamper indicator in place when the door is in the closed position and the tamper indicator is in the stowed position. The protuberance can include a ledge extending from a lateral wall of the housing.

The system can also include an adhesive layer configured to securely fasten the tamper indicator in the tamper-indicating position.

The door can include an opening. In at least one example, the tamper indicator includes a protuberance that extends into the opening when the tamper indicator is in the tamper-indicating position. The protuberance can include a latching surface that is configured to latch onto an outer surface of the door when the tamper indicator is in the tamper-indicating position.

Certain examples of the present disclosure provide a vehicle, such as an aircraft, including an internal cabin, a seat within a passenger section of the internal cabin, and a life vest box mounted to the seat, as described herein.

Certain examples of the present disclosure provide a method for indicating tampering, the method including moveably coupling a door to a housing defining an internal compartment for storing one or more items, wherein the door is moveable between a closed position in which the internal compartment is closed, and an open position in which the internal compartment is accessible; and coupling a tamper indicator to one or both of the housing or the door, wherein the tamper indicator is moveable between a stowed position and a tamper-indicating position.

### BRIEF DESCRIPTION OF THE DRAWINGS

FIG. 1 illustrates a simplified front view of a container having a system for indicating tampering, according to an example of the present disclosure.

FIG. 2 illustrates a perspective front view of an aircraft, according to an example of the present disclosure.

FIG. 3 illustrates a perspective interior view of an internal cabin of an aircraft, according to an example of the present disclosure.

FIG. 4 illustrates an isometric front view of a seating system, according to an example of the present disclosure.

FIG. 5 illustrates an isometric front view of a container having a system in a stowed, untampered position, according to an example of the present disclosure.

FIG. 6 illustrates an isometric front view of the container of FIG. 5 having the system in a tamper-indicating position.

FIG. 7 illustrates a transverse internal view of the container of FIG. 5 having the system in the stowed, untampered position.

FIG. 8 illustrates a transverse internal view of the container of FIG. 5 having the system in the tamper-indicating position.

FIG. 9 illustrates a lateral view of a tamper indicator disengaging from a ledge within a container, according to an example of the present disclosure.

FIG. 10 illustrates a lateral view of the tamper indicator biased against an interior surface of a door, according to an example of the present disclosure.

FIG. 11 illustrates a lateral view of the tamper indicator biased against an interior surface of a door, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

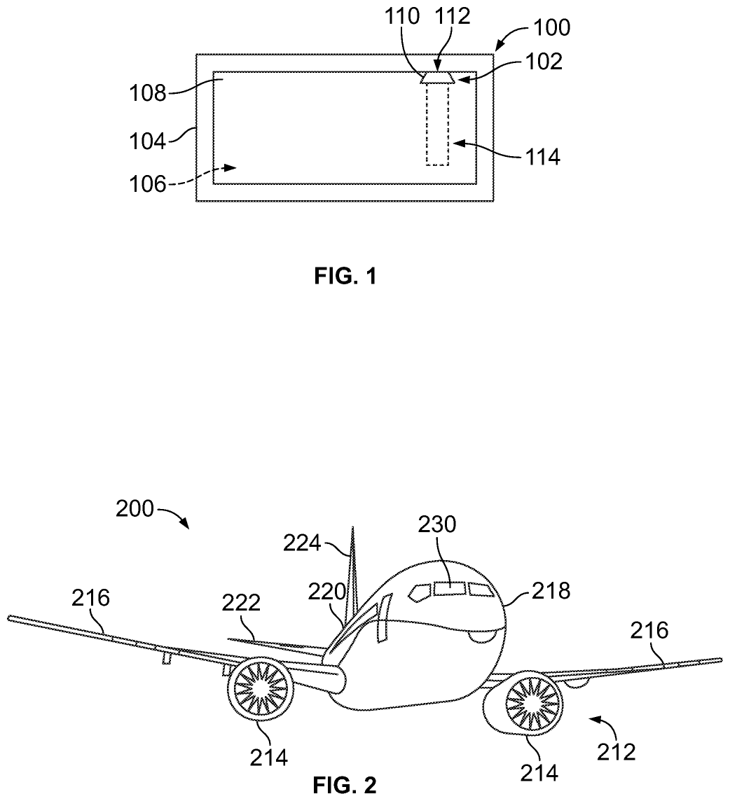

FIG. 1 illustrates a simplified front view of a container 100 having a system 102 for indicating tampering, according to an example of the present disclosure. The container 100 includes a housing 104 defining an internal compartment 106 for storing one or more items. A door 108 is moveably coupled to the container 100 and is configured to be moved from a closed position, in which the internal compartment 106 is closed, and an open position, in which the internal compartment 106 is accessible.

The system 102 is coupled to one or both of the housing 104 and/or the door 108. The system 102 includes a tamper indicator 110 that is moveable between a stowed position 112 and a tamper-indicating position 114. In at least one example, the tamper indicator 110 is spring-biased. In at least one example, the tamper indicator 110 is a flag, beam, tab, and/or the like. In the stowed position 112, the tamper indicator 110 is secured within the internal compartment 106 such that the tamper indicator 110 is not in a position to indicate that the container 100 has been opened and tampered. In the tamper-indicating position 114, the tamper indicator 110 is deployed (such as via spring force) and biased against an internal surface of the door 108. In this manner, the tamper indicator 110 is clearly visible to indicate that the door 108 has been opened, thereby evincing potential tampering.

In at least one example, the door 108 is clear and transparent so that the tamper indicator 110 is visible therethrough. As another example, the door 108 can be opaque, and have one or more openings formed therethrough. In this example, the openings expose one or more portions of the tamper indicator 110 in the tamper-indicating position.

In at least one example, the container 100 is a life vest box for an internal cabin of a vehicle. In this example, the item stored within the compartment 106 is a life vest. As another example, the container 100 is a stowage bin assembly within an internal cabin of a vehicle. In such an example, the container 100 can store an item such as a fire extinguisher, self-defense devices, and/or the like. As another example, the container 100 is a closet. As another example, the container 100 is a safe box, which can be used to store items such as valuables, guns, and/or the like. The aforementioned examples are non-limiting. The container 100 can be used in various environments and settings, in which there is a need to evince potential tampering.

As described herein, the container 100 includes the housing 104 defining the internal compartment 106 for storing one or more items. The door 108 is moveably coupled to the housing 104. The door 108 is moveable between a closed position in which the internal compartment 106 is closed, and an open position in which the internal compartment 106 is accessible. The system 102 for indicating tampering includes the tamper indicator 110 coupled to the housing 104 and/or the door 108. The tamper indicator 110 is moveable between the stowed position 112 and the tamper-indicating position 114. In at least one example, the tamper indicator 110 is moved from the stowed position 112 to the tamper-indicating position 114 as the door 108 is moved from the closed position toward the open position. In at least one example, the tamper indicator 110 is spring-biased. In at least one example, the door 108 is transparent, and the tamper indicator 110 in the tamper-indicating position 114 is visible through the door 108.

In at least one example, the tamper indicator 110 can be electrically powered, such as through a battery, a source of power within a vehicle, or the like. The tamper indicator 110 can be moveable through a powered actuator. For example, a rotary motor can be coupled to the tamper indicator 110.

FIG. 2 illustrates a perspective front view of an aircraft 200, according to an example of the present disclosure. The aircraft 200 includes a propulsion system 212 that includes engines 214, for example. Optionally, the propulsion system 212 may include more engines 214 than shown. The engines 214 are carried by wings 216 of the aircraft 200. In other examples, the engines 214 may be carried by a fuselage 218 and/or an empennage 220. The empennage 220 may also support horizontal stabilizers 222 and a vertical stabilizer 224.

The fuselage 218 of the aircraft 200 defines an internal cabin 230, which includes a flight deck or cockpit, one or more work sections (for example, galleys, personnel carry-on baggage areas, and the like), one or more passenger sections (for example, first class, business class, and coach sections), one or more lavatories, and/or the like.

Referring to FIGS. 1 and 2, the container 100 having the system 102 can be used within the internal cabin 230. For example, the container 100 can be a life vest box secured to a seat within a passenger section of the internal cabin 230.

Optionally, instead of an aircraft, examples of the present disclosure may be used with various other vehicles, such as automobiles, buses, locomotives and train cars, watercraft, and the like. Also, optionally, instead of a vehicle, examples of the present disclosure can be used with fixed structures, such as commercial and residential buildings.

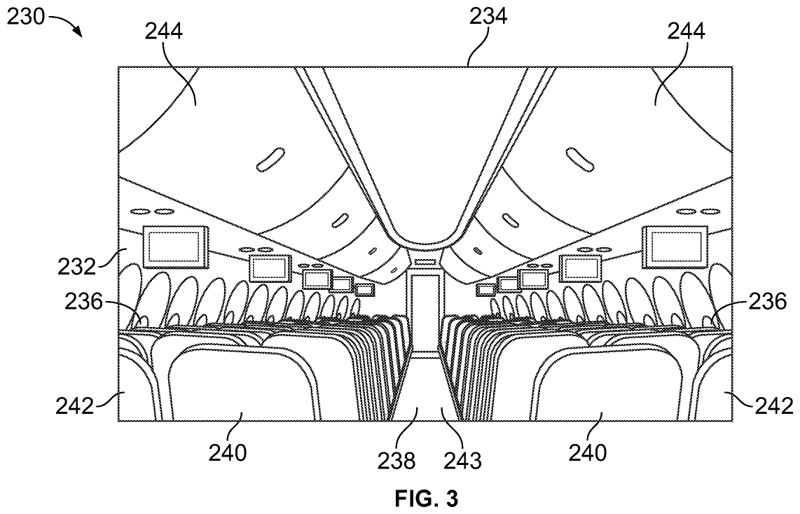

FIG. 3 illustrates a perspective interior view of an internal cabin 230 of an aircraft, according to an example of the present disclosure. The internal cabin 230 includes outboard walls 232 and a ceiling 234. Windows 236 may be formed within the outboard walls 232. A floor 238 supports rows of seats 240. As shown in FIG. 3, a row 242 may include three seats 240 on either side of an aisle 243. However, the row 242 may include more or fewer seats 240 than shown. Additionally, the internal cabin 230 may include more aisles than shown.

Referring to FIGS. 1-3, in at least one example, the container 100 is secured to a seat 240 within the internal cabin 230. As another example, the container 100 can be a stowage bin assembly 244, which can be above one or more seats 240.

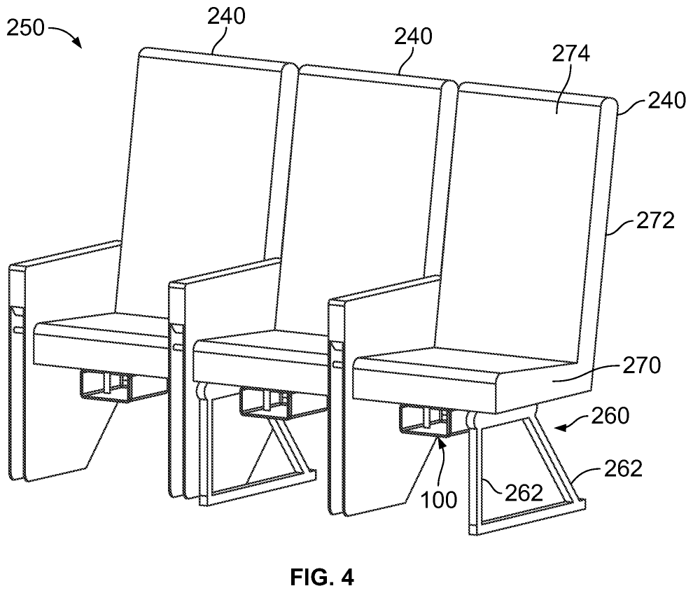

FIG. 4 illustrates an isometric front view of a seating system 250, according to an example of the present disclosure. The seating system 250 includes plural seats 240, which are configured to be disposed within the internal cabin 230 (shown in FIGS. 2 and 3). The seat system 250 can include more or fewer seats 240 than shown.

The seats 240 include a base 260, which may include legs 262 that may be secured to seat tracks within an internal cabin. In at least one example, securing studs (such as shear studs) downwardly extend from lower surfaces of the base 260. The securing studs are securely retained within the seat tracks of the floor 238. The seat tracks are configured to securely couple to the securing studs to secure the seat 240 in place. The base 260 supports a seat pan 270 and a backrest 272, which includes a headrest 274. Armrests may be pivotally secured to the backrest 272.

The seats 240 may be sized and shaped differently than shown in FIG. 4. The seats 240 may include more or fewer components than shown in FIG. 4. It is to be understood that the seats 240 shown in FIG. 4 are merely examples of seats that may be disposed within an internal cabin of a vehicle.

In at least one example, the container 100 is secured to the seat 240. For example, the container 100 is mounted to an underside of the seat pan 270. In this example, the container 100 is a life vest box configured to store a life vest.

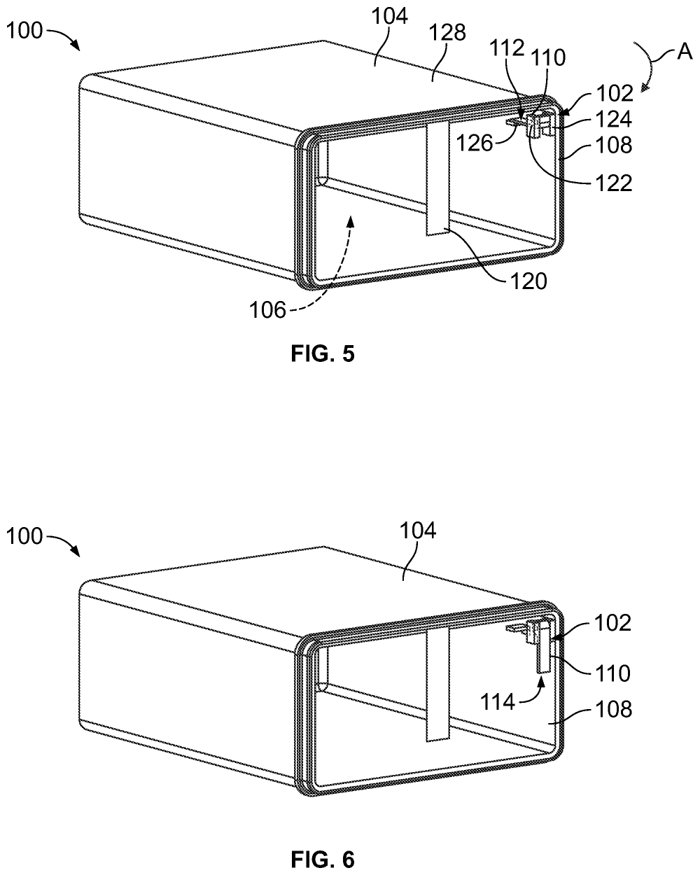

FIG. 5 illustrates an isometric front view of the container 100 having the system 102 in the stowed position 112, according to an example of the present disclosure. The container 100 shown in FIG. 5 is a life vest box for use within an internal cabin of a vehicle. The container 100 can include a pull strap 120 that is configured to be pulled outwardly (whether upwardly or downwardly) to open the door 108 about a pivot axis in the direction of arc A.

The system 102 includes the tamper indicator 110, such as a flat beam, tab, flag, and/or the like. The tamper indicator 110 includes a proximal end 122 that is moveably secured to a bracket 124 that is secured to an interior surface of the door 108. The proximal end 122 is coupled to a spring, such as a torsion spring, retained by the bracket 124. In the stowed position 112, the tamper indicator 110 is held in place by one or more features within the compartment 106. In the stowed position 112, a main body 126 of the tamper indicator 110 can be disposed in a plane that is parallel or substantially parallel (such as within +/−5 degrees) with a lower surface of a top wall 128 of the housing 104.

As described herein, in at least one example, the tamper indicator 110 includes the proximal end 122 moveably secured to the bracket 124, which is secured to an interior surface of the door 108. The main body 126 of the tamper indicator 110 extends between the proximal end 122 and a distal end. In at least one example, a torsion spring couples the proximal end 122 to the bracket 124.

FIG. 6 illustrates an isometric front view of the container 100 of FIG. 5 having the system 102 in the tamper-indicating position 114. In the tamper-indicating position 114, the tamper indicator 110 is biased against an interior surface of the door 108. In in at least one example, the door 108 is transparent, thereby allowing the tamper indicator 110 to be readily visible through the door 108.

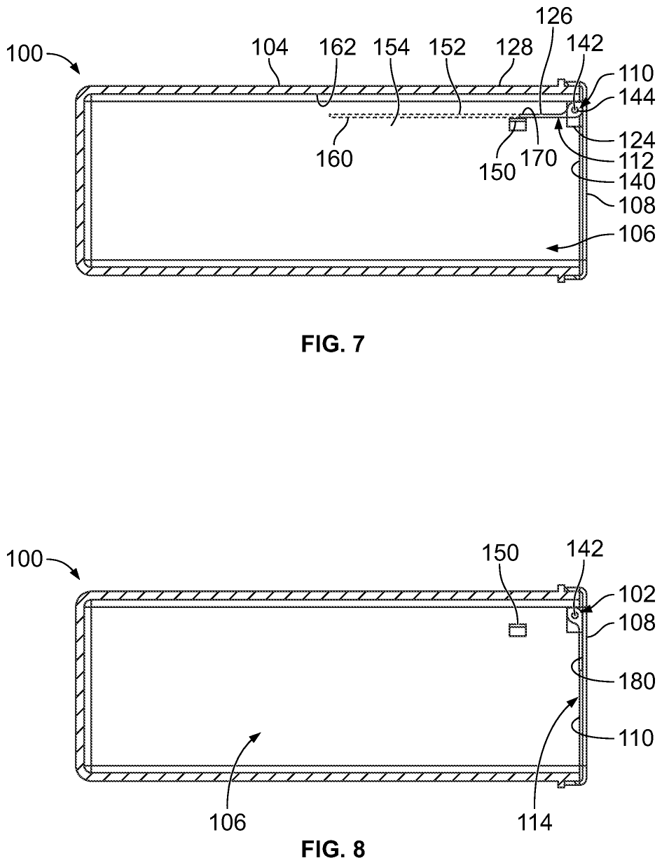

FIG. 7 illustrates a transverse internal view of the container 100 of FIG. 5 having the system in the stowed position 112. The proximal end 122 of the tamper indicator 110 is moveably secured to the bracket 124, which is secured to the interior surface 140 of the door 108 proximate to the top wall 128 of the housing 104. The proximal end 122 is coupled to the spring 142, such as a torsion spring, retained by the bracket 124. The spring 142 exerts a spring force into the tamper indicator 110. The spring force is exerted to rotate the tamper indicator 110 about a rotation axis 144 toward the interior surface 140 of the door 108.

In the stowed position, the tamper indicator 110 is held in place by a protuberance within the compartment 106. In at least one example, the protuberance is a ledge 150 that outwardly extends from an interior surface 152 of a lateral wall 154 of the housing 104. Optionally, the protuberance can be a latch, clasp, sleeve, or the like that is disposed at other areas, such as extending downwardly from the lower surface 162 of the top wall 128.

The tamper indicator 110 is spring-biased and configured to bias against the interior surface 140 when the door 108 is opened, thereby causing the distal end 170 to lose contact with the ledge 150. As such, the spring 142 forces the main body 126 and distal end 170 against the interior surface 140 of the door 108. Optionally, instead of a torsion spring, the tamper indicator 110 can be formed as a leaf spring that exerts the spring force without the need for a separate torsion spring.

In at least one example, in the stowed position, the main body 126 of the tamper indicator 110 is disposed in a plane 160 that is parallel or substantially parallel (such as within +/−5 degrees) with the lower surface 162 of the top wall 128 of the housing 104. In the stowed position, a distal end 170 of the tamper indicator 110 is supported on top of the ledge 150. In at least one example, the tamper indicator 110 is sized such that the distal end 170 is only supported on top of the ledge 150 when the door 108 is in the closed position. As the door 108 is rotated open, the distal end 170 disengages from the ledge 150.

FIG. 8 illustrates a transverse internal view of the container 100 of FIG. 5 having the system in the tamper-indicating position 114. In the tamper-indicating position 114, the spring force exerted by the spring 142 biases the tamper indicator 110 against the interior surface 180 of the door 108, which provides an indication that the door 108 was previously opened, and the contents (such as a life vest) within the compartment 106 may have been manipulated and tampered.

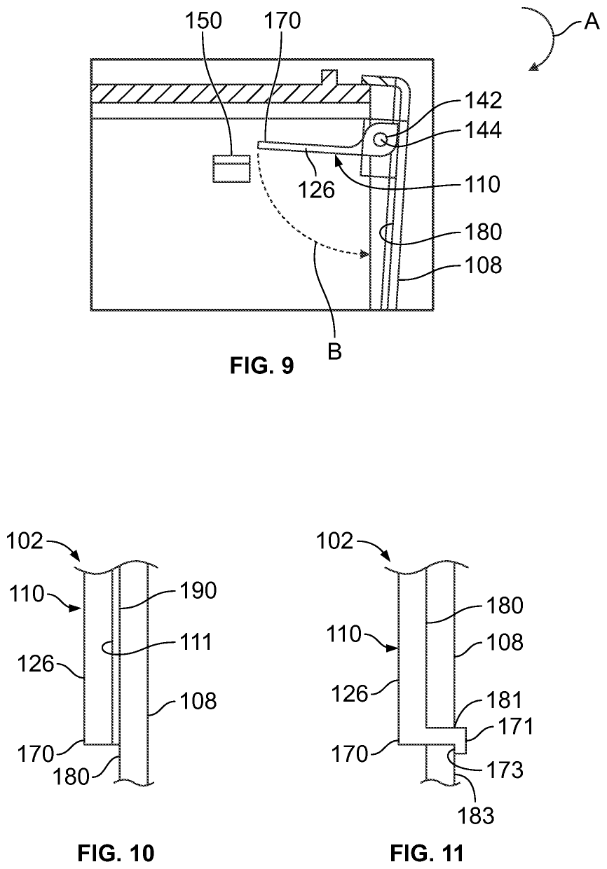

FIG. 9 illustrates a lateral view of the tamper indicator 110 disengaging from the ledge 150 within the container 100, according to an example of the present disclosure. As the door 108 is opened outwardly about a pivot axis in the direction of arc A, the distal end 170 of the tamper indicator 110 disengages from (that is, loses contact with) the ledge 150. As such, the spring force exerted by the spring 142 rotates the tamper indicator 110 about the rotation axis 144 in the direction of arc B and biases the main body 126 and the distal end 170 against the interior surface 180 of the door 108.

As noted, the tamper indicator 110 is sized such that the distal end 170 is supported on the ledge 150 when the door 108 is in the closed position. As the door 108 is opened, the distal end 170 loses contact with the ledge 150. Accordingly, after the door 108 is opened, an individual is unable to reset the tamper indicator 110 by hand, as the individual is unable to move the tamper indicator 110 in a position to engage the ledge 150 while the door 108 is closed. Instead, the container 100 may include one or more features, such as passages, channels, or openings, that are configured to receive an operative end of a specialized tool that is used to reset the tamper indicator 110 into the stowed position.

FIG. 10 illustrates a lateral view of the tamper indicator 110 biased against the interior surface 180 of the door 108, according to an example of the present disclosure. An adhesive layer 190 can be secured to an outboard surface 111 of the tamper indicator 110 or the interior surface 180 of the door 108. Thus, when the tamper indicator 110 is biased against the interior surface 180, the adhesive layer 190 securely fastens the tamper indicator 110 to the door 108, thereby preventing an individual from pivoting the tamper indicator 110 away from the door 108 after the tamper indicator 110 is biased into the tamper-indicating position.

The adhesive layer 190 can be or include two-sided tape, a glue, and/or the like. Optionally, the system 102 may not include an adhesive layer.

FIG. 11 illustrates a lateral view of the tamper indicator 110 biased against the interior surface of the door 108, according to an example of the present disclosure. The tamper indicator 110 can include a protuberance 171, such as a tab, barb, stud, or the like, that forwardly extends from the distal end 170 when the tamper indicator 110 is in the tamper-indicating position. The door 108 can include a reciprocal opening 181 that allows the protuberance 171 to pass therein and/or therethrough so as to be readily visible when the tamper indicator 110 is in the tamper-indicating position.

In at least one example, the protuberance 171 can include a latching surface 173, such as a ramp, ledge, ridge, or the like, that hooks onto an outer surface 183 of the door 108 when the tamper indicator 110 is in the tamper-indicating position. The latching surface 173 can be resilient and deflectable to fit through the opening 181, and latch onto the outer surface 183. When the latching surface 173 is latched to the outer surface 183, a specialized tool can be used to remove the latching surface 173 from the outer surface 183 and reset the tamper indicator 110 into the stowed position.

Optionally, the protuberance 171 may not include the latching surface 173. Also, optionally, the tamper indicator 110 may not include the latching surface 173.

Further, the disclosure comprises examples according to the following clauses:

Clause 1. A container comprising:
a housing defining an internal compartment for storing one or more items;
a door moveably coupled to the housing, wherein the door is moveable between a closed position in which the internal compartment is closed, and an open position in which the internal compartment is accessible; and
a system for indicating tampering, the system comprising a tamper indicator coupled to one or both of the housing or the door, wherein the tamper indicator is moveable between a stowed position and a tamper-indicating position.

Clause 2. The container of Clause 1, wherein the tamper indicator is moved from the stowed position to the tamper-indicating position as the door is moved from the closed position toward the open position.

Clause 3. The container of Clauses 1 or 2, wherein the tamper indicator is spring-biased.

Clause 4. The container of any of Clauses 1-3, wherein the door is transparent, and wherein the tamper indicator in the tamper-indicating position is visible through the door.

Clause 5. The container of any of Clauses 1-4, wherein the container is a life vest box configured to be secured to a seat within an internal cabin of a vehicle.

Clause 6. The container of any of Clauses 1-5, wherein the tamper indicator comprises:
a proximal end moveably secured to a bracket, wherein the bracket is secured to an interior surface of the door;
a distal end; and
a main body extending between the proximal end and the distal end.

Clause 7. The container of Clause 6, wherein a torsion spring couples the proximal end to the bracket.

Clause 8. The container of any of Clauses 1-7, wherein the tamper indicator in the tamper-indicating position is biased against an interior surface of the door.

Clause 9. The container of any of Clauses 1-8, wherein the housing comprises a protuberance extending from one or more interior surfaces, wherein the protuberance holds the tamper indicator in place when the door is in the closed position and the tamper indicator is in the stowed position.

Clause 10. The container of Clause 9, wherein the protuberance comprises a ledge extending from a lateral wall of the housing.

Clause 11. The container of any of Clauses 1-10, wherein the system further comprises an adhesive layer configured to securely fasten the tamper indicator in the tamper-indicating position.

Clause 12. The container of any of Clauses 1-11, wherein the door comprises an opening, and wherein the tamper indicator includes a protuberance that extends into the opening when the tamper indicator is in the tamper-indicating position.

Clause 13. The container of Clause 12, wherein the protuberance comprises a latching surface that is configured to latch onto an outer surface of the door when the tamper indicator is in the tamper-indicating position.

Clause 14. An aircraft comprising:
an internal cabin;
a seat with the internal cabin; and
a life vest box mounted to the seat, the life vest box comprising:
   a housing defining an internal compartment for storing a life vest, wherein the housing comprises a protuberance extending from one or more interior surfaces;
   a door moveably coupled to the housing, wherein the door is moveable between a closed position in which the internal compartment is closed, and an open position in which the internal compartment is accessible; and
   a system for indicating tampering, the system comprising a tamper indicator coupled to one or both of the housing or the door, wherein the tamper indicator is moveable between a stowed position and a tamper-indicating position, wherein the protuberance holds the tamper indicator in place when the door is in the closed position and the tamper indicator is in the stowed position, and wherein the tamper indicator in the tamper-indicating position is biased against an interior surface of the door.

Clause 15. The aircraft of Clause 14, wherein the tamper indicator is moved from the stowed position to the tamper-indicating position as the door is moved from the closed position toward the open position.

Clause 16. The aircraft of Clauses 14 or 15, wherein the tamper indicator is spring-biased.

Clause 17. The aircraft of any of Clauses 14-16, wherein the door is transparent, and wherein the tamper indicator in the tamper-indicating position is visible through the door.

Clause 18. The aircraft of any of Clauses 14-17, wherein the tamper indicator comprises:
a proximal end moveably secured to a bracket, wherein the bracket is secured to an interior surface of the door, and wherein a torsion spring couples the proximal end to the bracket;
a distal end;
a main body extending between the proximal end and the distal end.

Clause 19. The aircraft of any of Clauses 14-18, wherein the protuberance comprises a ledge extending from a lateral wall of the housing.

Clause 20. A method for indicating tampering, the method comprising:
moveably coupling a door to a housing defining an internal compartment for storing one or more items, wherein the door is moveable between a closed position in which the internal compartment is closed, and an open position in which the internal compartment is accessible; and
coupling a tamper indicator to one or both of the housing or the door, wherein the tamper indicator is moveable between a stowed position and a tamper-indicating position.

As described herein, examples of the present disclosure provide efficient and effective systems and methods for indicating tampering of a container, such as a life vest box within an internal cabin of a vehicle.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the parameters of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A container comprising:
a housing defining an internal compartment for storing one or more items;
a door moveably coupled to the housing, wherein the door is moveable between a closed position in which the internal compartment is closed, and an open position in which the internal compartment is accessible; and
a system for indicating tampering, the system comprising a tamper indicator coupled to one or both of the housing or the door, wherein the tamper indicator is moveable between a stowed position and a tamper-indicating position.

2. The container of claim 1, wherein the tamper indicator is moved from the stowed position to the tamper-indicating position as the door is moved from the closed position toward the open position.

3. The container of claim 1, wherein the tamper indicator is spring-biased.

4. The container of claim 1, wherein the door is transparent, and wherein the tamper indicator in the tamper-indicating position is visible through the door.

5. The container of claim 1, wherein the container is a life vest box configured to be secured to a seat within an internal cabin of a vehicle.

6. The container of claim 1, wherein the tamper indicator comprises:
a proximal end moveably secured to a bracket, wherein the bracket is secured to an interior surface of the door;
a distal end; and
a main body extending between the proximal end and the distal end.

7. The container of claim 6, wherein a torsion spring couples the proximal end to the bracket.

8. The container of claim 1, wherein the tamper indicator in the tamper-indicating position is biased against an interior surface of the door.

9. The container of claim 1, wherein the housing comprises a protuberance extending from one or more interior surfaces, wherein the protuberance holds the tamper indicator in place when the door is in the closed position and the tamper indicator is in the stowed position.

10. The container of claim 9, wherein the protuberance comprises a ledge extending from a lateral wall of the housing.

11. The container of claim 1, wherein the system further comprises an adhesive layer configured to securely fasten the tamper indicator in the tamper-indicating position.

12. The container of claim 1, wherein the door comprises an opening, and wherein the tamper indicator includes a protuberance that extends into the opening when the tamper indicator is in the tamper-indicating position.

13. The container of claim 12, wherein the protuberance comprises a latching surface that is configured to latch onto an outer surface of the door when the tamper indicator is in the tamper-indicating position.

14. An aircraft comprising:
an internal cabin;
a seat with the internal cabin; and
a life vest box mounted to the seat, the life vest box comprising:
a housing defining an internal compartment for storing a life vest, wherein the housing comprises a protuberance extending from one or more interior surfaces;
a door moveably coupled to the housing, wherein the door is moveable between a closed position in which the internal compartment is closed, and an open position in which the internal compartment is accessible; and
a system for indicating tampering, the system comprising a tamper indicator coupled to one or both of the housing or the door, wherein the tamper indicator is moveable between a stowed position and a tamper-indicating position, wherein the protuberance holds the tamper indicator in place when the door is in the closed position and the tamper indicator is in the stowed position, and wherein the tamper indicator in the tamper-indicating position is biased against an interior surface of the door.

15. The aircraft of claim 14, wherein the tamper indicator is moved from the stowed position to the tamper-indicating position as the door is moved from the closed position toward the open position.

16. The aircraft of claim 14, wherein the tamper indicator is spring-biased.

17. The aircraft of claim 14, wherein the door is transparent, and wherein the tamper indicator in the tamper-indicating position is visible through the door.

18. The aircraft of claim 14, wherein the tamper indicator comprises:
a proximal end moveably secured to a bracket, wherein the bracket is secured to an interior surface of the door, and wherein a torsion spring couples the proximal end to the bracket;
a distal end;
a main body extending between the proximal end and the distal end.

19. The aircraft of claim 14, wherein the protuberance comprises a ledge extending from a lateral wall of the housing.

20. A method for indicating tampering, the method comprising:
moveably coupling a door to a housing defining an internal compartment for storing one or more items, wherein the door is moveable between a closed position in which the internal compartment is closed, and an open position in which the internal compartment is accessible; and
coupling a tamper indicator to one or both of the housing or the door, wherein the tamper indicator is moveable between a stowed position and a tamper-indicating position.
